(19) United States
(12) Patent Application Publication
(10) Pub. No.: US 2026/0142388 A1
(43) Pub. Date: May 21, 2026

(54) A SUPERCONDUCTOR CONNECTOR ASSEMBLY AND METHODS OF ASSEMBLY AND DISASSEMBLY

(71) Applicant: United Kingdom Atomic Energy Authority, Abingdon Oxfordshire (GB)

(72) Inventors: Jack Richard Greenwood, Rotherham (GB); Steven Mark Allen, Abingdon Oxfordshire (GB); Julian Holt, Abingdon Oxfordshire (GB); Peter Muscat, Abingdon Oxfordshire (GB); Jan Sprengel, Abingdon Oxfordshire (GB); Yannik Dieudonne, Abingdon Oxfordshire (GB); Peter Daniels, Abingdon Oxfordshire (GB); Chris Lamb, Abingdon Oxfordshire (GB); Tim Jones, Abingdon Oxfordshire (GB)

(73) Assignee: United Kingdom Atomic Energy Authority, Abingdon Oxfordshire (GB)

(21) Appl. No.: 19/114,945

(22) PCT Filed: Sep. 27, 2023
(86) PCT No.: PCT/GB2023/052502

§ 371 Date: Mar. 25, 2025

(30) Foreign Application Priority Data
Sep. 27, 2022 (GB) 2214116.2

(51) Int. Cl. H01R 4/68; H01R 4/50

(52) U.S. Cl. CPC H01R 4/68; H01R 4/5083

(57) ABSTRACT

According to an aspect, there is provided a superconductor connector assembly for electrically connecting a first superconductor cable and a second superconductor cable, the superconductor connector assembly comprising: at least one first superconducting cable terminal, the first superconducting cable terminal comprising at least one first opening for receiving an end of the first superconductor cable; at least one second superconducting cable terminal, the second superconducting cable terminal comprising at least one second opening for receiving an end of the second superconductor cable; and a surrounding part that is configured to receive and surround the first superconducting cable terminal and the second superconducting cable terminal, wherein the first and second openings overlap when the first superconducting cable terminal and the second superconducting cable terminal are received in the surrounding part, wherein the surrounding part is made from a material that has a thermal expansion coefficient different from a thermal expansion coefficient of the first and second superconducting cable terminals such that the first superconducting cable terminal and the second superconducting cable terminal are compressed together and form an electrical interface at an operating temperature of the superconductor connector assembly.

### FIELD OF THE INVENTION

The present disclosure relates to a superconductor connector assembly and methods of assembly and disassembly. In particular, although not exclusively, the present disclosure relates to the application of the superconductor connector assembly and methods of assembly and disassembly to a nuclear fusion reactor.

### BACKGROUND OF THE INVENTION

A tokamak is a nuclear fusion reactor that may confine a mix of deuterium and tritium in plasma form by a magnetic field with a toroidal geometry. A spherical tokamak is a compact version, in which the radius at the centre of the toroid is minimised. Such a compact arrangement is still topologically a toroid, but it is referred to as a spherical tokamak due to its spherical appearance.

FIG. 1 shows a cutaway view of a previously-proposed tokamak arrangement. Superconducting magnet assemblies 1, 2, 3 are disposed around a toroidal vacuum vessel 4. Superconducting magnet assemblies 1, 2, 3 may be formed from superconducting cables.

Superconducting magnet assembly 1 comprises toroidal field coils which extend around a section of the toroidal vacuum vessel 4. A plurality of such toroidal field coils may be provided and may be distributed about a circumference of the toroidal vacuum vessel 4. The toroidal field coils provide a magnetic field with field lines circulating around the centre of the toroidal vacuum vessel 4 and help to contain the plasma.

Superconducting magnet assembly 2 comprises poloidal field coils which extend about the circumference of the toroidal vacuum vessel 4. A plurality of such poloidal field coils may be provided and they may be distributed along a central axis of the toroidal vacuum vessel 4. The poloidal field coils help to shape and stabilise the plasma.

Superconducting magnet assembly 3 comprises a central solenoid that extends through the centre of the toroidal vacuum vessel 4. The central solenoid may induce a current in the plasma so as to heat the plasma.

A benefit of the spherical tokamak is its compact nature, which is expected to reduce the capital cost. Other benefits include attractive plasma physics features. A key efficiency parameter, called beta, is the ratio of the thermal energy density stored in the plasma to that stored in the confining magnetic field. A spherical tokamak can accommodate much higher values of beta than a conventional tokamak because of the high ratio of plasma current to magnetic field it can contain.

However, the more compact arrangement of the spherical tokamak presents challenges. For example, there may not be sufficient space for shielding to allow the magnet assemblies 1, 2, 3 to survive the full life of the reactor. The magnetic assemblies and their superconducting cables may therefore require replacement during the life of the reactor. It is therefore desirable to allow ready access to the magnet assemblies. To this end, it has previously been proposed to provide the superconducting cables with disconnectable, easily demountable, or remountable joints that permit disassembly of the magnet assemblies. However, previously-proposed superconducting cable joints are not easily disconnected, e.g. by remote means, and add electrical resistance that impacts on their superconducting performance.

### SUMMARY OF THE INVENTION

According to a first specific aspect, there is provided a superconductor connector assembly for electrically connecting a first superconductor cable and a second superconductor cable, the superconductor connector assembly comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that is configured to receive and surround the first superconducting cable terminal and the second superconducting cable terminal,
wherein the first and second openings overlap when the first superconducting cable terminal and the second superconducting cable terminal are received in the surrounding part,
wherein the surrounding part is made from a material that has a thermal expansion coefficient different from a thermal expansion coefficient of the first and second superconducting cable terminals such that the first superconducting cable terminal and the second superconducting cable terminal are compressed together and form an electrical interface at an operating temperature of the superconductor connector assembly.

The first and second openings may overlap in a plane perpendicular to a longitudinal axis of the first and second openings. The first and second openings (and thus first and second superconductor cables) may extend alongside one another. Longitudinal axes of the first and second openings (and thus first and second superconductor cables) may be substantially parallel to one another.

The dimensions of the first and second superconducting cable terminals and the surrounding part may permit assembly of the superconductor connector assembly at room temperature (˜298 K). The surrounding part may contract such that the first and second superconducting cable terminals are compressed together at cryogenic temperatures, e.g., below approximately 100 K.

The first and second openings may be wider than the ends of the respective first and second superconductor cables. The first and second superconductor cables may be soldered into the first and second openings, e.g., with an Indium based solder. The solder may be soft (relative to the terminals) to minimise stress in the terminals being translated to the superconducting cables.

The superconductor connector assembly may be for a nuclear reactor, such as a nuclear fusion reactor, in particular a Tokamak reactor. The reactor may comprise the superconductor connector assembly. The superconductor connector assembly may be used in other superconductor applications, such as MRI, NMR, particle accelerators or any other application requiring superconductor connectors.

The superconductor connector assembly may provide an excellent electrical connection between the first and second superconductor cables, e.g., thanks to the contact pressure that may be obtained between the first and second superconducting cable terminals and without compromising the superconducting performance. The compressive stress may not be transferred to the first and second superconductor cables, which may otherwise degrade their superconducting properties.

The superconductor connector assembly may also provide a compact arrangement. Such a compact arrangement may be beneficial in a nuclear fusion reactor that may require a dense arrangement of superconducting cables to generate the necessary magnetic fields. The superconductor connector assembly may also readily permit disassembly and reassembly during maintenance of the reactor. The compact arrangement may leave enough space between each superconductor connector assembly for the connections to be robotically de-mounted and re-mounted.

Components of the superconductor connector assembly may be formed from materials that are not activated (e.g., not induced to be radioactive) in a radioactive environment. The first and second superconducting cable terminals may be formed from copper, such as oxygen free high conductivity copper. The surrounding part may be formed from aluminium.

The first superconducting cable terminal may be configured to surround the second superconducting cable terminal. The first superconducting cable terminal may be concentric with the second superconducting cable terminal. The first and/or second superconducting cable terminal may be concentric with the surrounding part. The superconductor connector assembly may further comprise a sleeve. The second superconducting terminal may surround the sleeve. The sleeve may be concentric with the first and/or second superconducting terminals. The sleeve may define a coolant passageway. The sleeve may be formed from stainless steel, Invar or any other material that contracts less than the first and/or second superconducting cable terminals.

The first superconducting cable terminal and the second superconducting cable terminal may be configured to be provided alongside one another, e.g., with neither of the first and second superconducting cable terminals surrounding the other of the first and second superconducting cable terminals. The first and second superconducting cable terminals may have substantially the same cross-sectional shape, e.g., they may be rectangular. The first and second superconducting cable terminals may have substantially the same dimensions.

The superconductor connector assembly may comprise a first pair of first and second superconducting cable terminals and a second pair of first and second superconducting cable terminals. An electrical insulator may be provided between the first pair of first and second superconducting cable terminals and the second pair of first and second superconducting cable terminals. Further pairs of first and second superconducting cable terminals may be provided, e.g., with insulators provided between neighbouring pairs. At least one further insulator may be provided between the surrounding part and the first and second superconducting cable terminals. The insulator(s) and/or further insulator may be formed from stainless steel.

The superconductor connector assembly may further comprise mechanical securing means or assembly configured to mechanically clamp the first and second superconducting cable terminals together. The mechanical securing means may be configured to provide a pre-stress or contact pressure that may compress the first and second superconducting cable terminals within the surrounding part, e.g., prior to the thermal contraction of the surrounding part. The mechanical securing means may additionally or alternatively take up any slack, e.g., due to manufacturing tolerances.

The mechanical securing means may comprise at least one wedge. A taper angle of the wedge may compress the first and second superconducting cable terminals within the surrounding part when the wedge is inserted between the surrounding part and at least one of the first and second superconducting cable terminals.

The superconductor connector assembly may further comprise at least one locking feature configured to lock or secure the at least one wedge into an inserted position in which the wedge may be between the surrounding part and at least one of the first and second superconducting cable terminals. The locking feature may comprise at least one screw that engages the surrounding part (or another part) and that may provide a reactive force to hold at least one wedge in place. A single locking feature may be configured to lock or secure a plurality of wedges into the inserted position.

The locking feature may comprise at least one screw that may extend in substantially the same direction as the first and second openings.

The locking feature may comprise a locking member, which may comprise extending arms that may engage respective wedges. The locking member comprise radially extending arms and may be cruciform, star shaped etc.

The locking feature may comprise a reactive portion that engages one end of the surrounding part. The locking member may engage the wedge(s) at another end of the surrounding part. The screw may couple the locking member to the reactive portion. The locking feature may comprise an insulator that extends between the first pair of first and second superconducting cable terminals and the second pair of first and second superconducting cable terminals. The screw may engage the insulator between the first and second pairs of superconducting cable terminals. The reactive portion may be part of the insulator. The screw may extend in the same direction as the cable openings.

The mechanical securing means may comprise at least one screw. The screw may engage and extend through the surrounding part so as to compress the first and second superconducting cable terminals within the surrounding part when tightened. The screw(s) may extend in a lateral direction, e.g. substantially perpendicular to a longitudinal direction of the first and second openings. For example, the screws may extend through a sidewall of the surrounding part.

The mechanical securing means may comprise at least one pair of opposing wedges. One of the wedges may be linearly movable with respect to the other of the wedges so that corresponding wedge surfaces slide with respect to one another and that a lateral dimension of the pair of opposing wedges is changed. The mechanical securing means may comprise a plurality of opposing wedge pairs in a saw tooth arrangement.

The mechanical securing means may comprise any other mechanical device, such as an over-centre cam, plunger, etc.

The mechanical securing means may be configured to be engaged or disengaged by remote tooling, e.g., remotely from the connector assembly and with the superconductor cables in situ. The locking feature may be configured to be engaged or disengaged by remote tooling, e.g., remotely from the connector assembly and with the superconductor cables in situ. Remotely connecting or disconnecting the connector assembly is advantageous due to the radioactive environment in which the connector assembly may operate.

The superconductor connector assembly may comprise at least one coolant passageway configured to permit the flow of coolant through the superconductor connector assembly. The coolant may comprise a cryogenic fluid. At least one of the first and second superconducting cable terminals may comprise the coolant passageway. The sleeve may define a coolant passageway. At least one coolant passageway may be formed by a gap between the surrounding part and at least one of the first and second superconducting cable terminals.

The first and second superconducting cable terminals may interlock with respect to one another. For example, one (or both) of the first and second superconducting cable terminals may comprise a protruding portion and the other (or both) of the first and second superconducting cable terminals may comprise a receiving portion. The receiving portion may be configured to receive the protruding portion. The electrical interface may be provided by opposing surfaces on the protruding portion and the receiving portion.

The superconductor connector assembly may comprise a plurality of first superconducting cable terminals and a plurality of second superconducting cable terminals. The superconductor connector assembly may comprise a plurality of pairs of first and second superconducting cable terminals. The pairs of the first and second superconducting cable terminals may be distributed in a circular arrangement. The pairs of the first and second superconducting cable terminals may be equiangularly distributed in the circular arrangement. Each pair of the first and second superconducting cable terminals may form a truncated sector of the circular arrangement. The surrounding part may surround the pairs of the first and second superconducting cable terminals distributed in the circular arrangement.

At least one of the first and second superconducting cable terminals may comprise a conducting portion and an insulating portion. The conducting portion may provide at least part of the electrical interface. An insulating portion of the first and second superconducting cable terminals may be provided at least at an interface between neighbouring pairs of the first and second superconducting cable terminals.

The surrounding part may comprise at least one rib. The rib may be a stiffening rib that may stiffen the surrounding part. The rib may increase the surface area of the surrounding part and may increase heat transfer rates, e.g., from a cryogenic fluid. The rib may be positioned to engage with a recess or rib of a neighbouring superconductor connector assembly. The rib(s) may aid stiffening, cooling and/or tessellation.

The superconductor connector assembly may be configured to substantially tesselate with other ones of the superconductor connector assembly. The surrounding part may comprise one or more ribs. One of the ribs may be configured to cooperate with a recess or another of the ribs of a neighbouring superconductor connector assembly.

According to a second specific aspect, there is provided an assembly comprising a plurality of the above-mentioned superconductor connector assemblies. The superconductor connector assemblies may tesselate with one another.

According to a third specific aspect, there is provided an assembly comprising the above-mentioned superconductor connector assembly, the first superconductor cable and the second superconductor cable.

The assembly may further comprise solder in the first and second openings. The solder may connect the first and second superconductor cables to the first and second superconducting cable terminals respectively. The solder may have a Young's modulus or hardness less than the material of the first and second superconducting cable terminals. The solder may have a Young's modulus or hardness that is an order of magnitude less than the material of the first and second superconducting cable terminals. The solder may have an Indium or soft solder eutectic base constituent. For example, the solder may be predominantly Indium or eutectic based.

According to a fourth specific aspect, there is provided a superconducting toroidal field coil assembly comprising the above-mentioned superconductor connector assembly comprising the plurality of pairs of first and second superconducting cable terminals. Each pair of the first and second superconducting cable terminals may be configured to connect ends of a superconducting toroidal field cable together. The superconductor connector assembly may be provided centrally with respect to a toroidal vessel, e.g., for a nuclear fusion reactor.

According to a fifth specific aspect, there is provided a method of assembling a superconductor connector assembly to electrically connect a first superconductor cable and a second superconductor cable, the superconductor connector comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that is configured to receive and surround the first superconducting cable terminal and the second superconducting cable terminal, wherein the surrounding part is made from a material that has a thermal expansion coefficient different from a thermal expansion coefficient of the first and second superconducting cable terminals,
wherein the method comprises:
   inserting the first superconducting cable terminal and the second superconducting cable terminal into the surrounding part such that the first and second openings overlap; and
   cryogenically cooling the superconductor connector assembly such that the first superconducting cable terminal and the second superconducting cable terminal are compressed together and form an electrical interface at an operating temperature of the superconductor connector assembly.

The method may further comprise, prior to cryogenically cooling the superconductor connector assembly, mechanically clamping the first and second superconducting cable terminals together to provide a pre-stress or contact pressure that compresses the first and second superconducting cable terminals within the surrounding part.

The method may further comprise locking the above-mentioned locking feature to lock or secure the at least one wedge into an inserted position.

The method may further comprise, prior to inserting the first superconducting cable terminal and the second superconducting cable terminal into the surrounding part, soldering an end of the first superconductor cable into the first opening of the first superconducting cable terminal; and soldering an end of the second superconductor cable into the second opening of the second superconducting cable terminal.

According to a sixth specific aspect, there is provided a method of disassembling a superconductor connector assembly to electrically disconnect a first superconductor cable and a second superconductor cable, the superconductor connector comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that receives and surrounds the first superconducting cable terminal and the second superconducting cable terminal such that the first and second openings overlap, wherein the surrounding part is made from a material that has a thermal expansion coefficient different from a thermal expansion coefficient of the first and second superconducting cable terminals such that the first superconducting cable terminal and the second superconducting cable terminal are compressed together and form an electrical interface at an operating temperature of the superconductor connector assembly,
wherein the method comprises:
   raising the temperature of the superconductor connector assembly from the operating temperature such that the first superconducting cable terminal and the second superconducting cable terminal are decompressed; and
   loosening or removing at least one of the first superconducting cable terminal and the second superconducting cable terminal from the surrounding part.

The method may further comprise releasing the mechanical clamp clamping the first and second superconducting cable terminals together. The method may further comprise unlocking the above-mentioned locking feature to unlock or loosen the at least one wedge from the inserted position.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 is a cutaway schematic view of a previously-proposed tokamak nuclear fusion reactor;

FIGS. 2a and 2b (collectively FIG. 2) are perspective and side-sectional views respectively of a superconductor connector assembly according to an example of the present disclosure;

FIG. 3 is a perspective view of a superconductor connector assembly according to another example of the present disclosure;

FIGS. 4a and 4b (collectively FIG. 4) are cutaway perspective and side-sectional views respectively of a superconductor connector assembly according to another example of the present disclosure;

FIGS. 5a and 5b (collectively FIG. 5) are cutaway perspective and side-sectional views respectively of a superconductor connector assembly according to another example of the present disclosure;

FIGS. 6a and 6b (collectively FIG. 6) are perspective and side-sectional views respectively of a superconductor connector assembly according to another example of the present disclosure;

FIGS. 7a and 7b (collectively FIG. 7) are perspective and side-sectional views respectively of a superconductor connector assembly according to another example of the present disclosure;

FIGS. 8a, 8b and 8c (collectively FIG. 8) are cutaway perspective, perspective and side-sectional views respectively of a superconductor connector assembly according to another example of the present disclosure;

FIG. 9 is a perspective view of a superconductor connector assembly according to another example of the present disclosure;

FIG. 10 is an end view of an array of superconductor connector assemblies according to another example of the present disclosure;

FIG. 11 is a perspective view of an array of superconductor connector assemblies according to another example of the present disclosure;

FIG. 12 is a perspective view of a superconductor connector assembly according to a further example of the present disclosure;

FIG. 13 is a sectional plan view of the superconductor connector assembly according to the further example of the present disclosure;

FIGS. 14a and 14b (collectively FIG. 14) are sectional plan views of part of the superconductor connector assembly according to the further example of the present disclosure, with FIG. 14a showing the first and second superconducting cable terminals disassembled and FIG. 14b showing the first and second superconducting cable terminals assembled together;

FIG. 15 is a perspective view of a superconducting toroidal field coil assembly according to a yet further example of the present disclosure;

FIG. 16 is a sectional perspective view of the superconductor connector assembly according to the further example of the present disclosure;

FIG. 17 is a flowchart depicting a method of assembly according to another example of the present disclosure; and

FIG. 18 is a flowchart depicting a method of disassembly according to another example of the present disclosure.

### DETAILED DESCRIPTION OF EMBODIMENTS

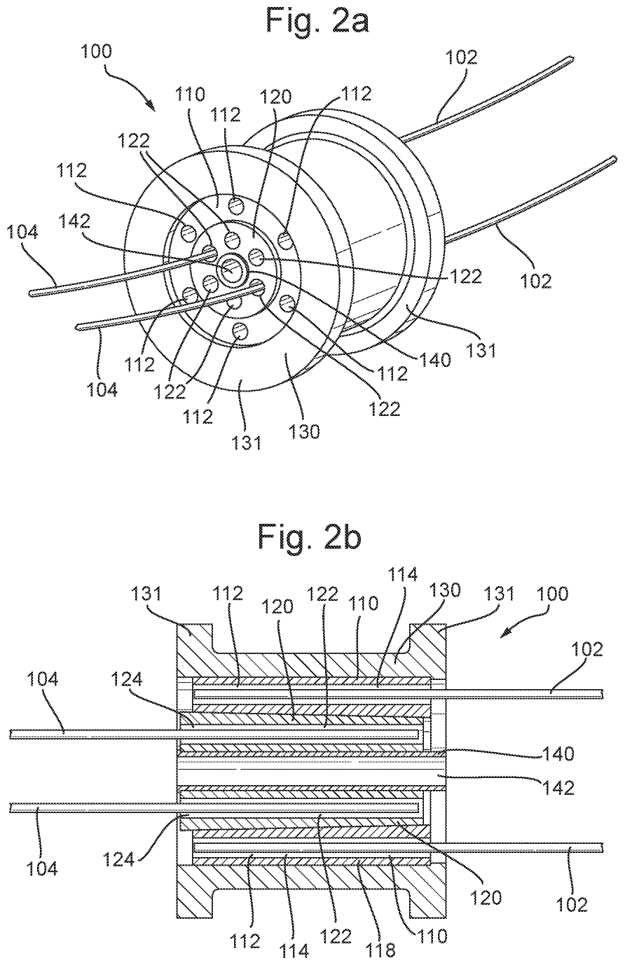

With reference to FIG. 2, the present disclosure relates to a superconductor connector assembly 100 for electrically connecting a first superconductor cable 102 and a second superconductor cable 104. The superconductor connector assembly 100 may connect superconducting cables of a nuclear reactor, such as a nuclear fusion reactor, in particular a Tokamak reactor. The superconducting cables 102, 104 may form magnetic coils that contribute to one or more magnetic fields of the reactor. Accordingly, components of the superconductor connector assembly 100 may be formed from materials that are not activated (e.g., not induced to be radioactive) in a radioactive environment. However, it is also envisaged that the superconductor connector assembly 100 may be used in other superconductor applications, such as MRI, NMR, particle accelerators or any other application requiring superconductor connectors.

The superconductor connector assembly 100 comprises a first superconducting cable terminal 110 and a second superconducting cable terminal 120. The first and second superconducting cable terminals 110, 120 are configured to cooperate with one another to form an electrical contact therebetween. In the depicted example, the first superconducting cable terminal 110 surrounds the second superconducting cable terminal 120, e.g., with an inner surface of the first superconducting cable terminal 110 that engages an outer surface of the second superconducting cable terminal 120. The first superconducting cable terminal 110 may be substantially tubular, in particular, with a circular cross-section. The first superconducting cable terminal 110 may be concentric with the second superconducting cable terminal 120. However, as shown in FIG. 2b, the inner surface of the first superconducting cable terminal 110 and the outer surface of the second superconducting cable terminal 120 may be tapered (e.g. such that diameter of the respective surfaces changes along the length of the terminals). The tapered surfaces may aid assembly, especially with remote-handling, and provide an interference fit.

The first superconducting cable terminal 110 comprises at least one first opening 112 for receiving an end of the first superconductor cable 102. As depicted, a plurality of first openings 112 may be provided, with each first opening receiving a corresponding first superconductor cable 102 or a strand/end of a single first superconductor cable comprising a plurality of strands/ends. The first openings 112 may be distributed around the first superconducting cable terminal 110, for example the first openings may be equiangularly distributed. Longitudinal axes of the first openings 112 may be substantially parallel to one another. As shown in FIG. 2b, the first openings 112 may extend all the way through the first superconducting cable terminal 110 such that the first openings 112 are open at both ends, but in an alternative arrangement the first openings 112 may be closed at one end of the first superconducting cable terminal 110. The first openings 112 may be circular, e.g., to receive circular cables types (such as CORC™), or substantially square/rectangular to receive CICC (cable-in-conduit) or stacked tape type arrangements.

Likewise, the second superconducting cable terminal 120 comprises at least one second opening 122 for receiving an end of the second superconductor cable 104. As depicted, a plurality of second openings 122 may be provided, with each second opening receiving a corresponding second superconductor cable 104 or a strand/end of a single second superconductor cable comprising a plurality of strands/ends. The second openings 122 may be distributed around the second superconducting cable terminal 120, for example the second openings may be equiangularly distributed. Longitudinal axes of the second openings 122 may be substantially parallel to one another. The second openings 122 may also be substantially parallel to the first openings 112. As shown in FIG. 2b, the second openings 122 may extend all the way through the second superconducting cable terminal 120 such that the second openings 122 are open at both ends, but in an alternative arrangement the second openings 122 may be closed at one end of the second superconducting cable terminal 120. As for the first openings, the second openings 122 may be circular, e.g., to receive circular cables types (such as CORC™), or substantially square/rectangular to receive CICC (cable-in-conduit) or stacked tape type arrangements. The first and second openings 112, 122 may have different shapes, e.g., such that the superconductor connector assembly provides an interface between different types of superconducting cables.

The superconductor connector assembly 100 further comprises a surrounding part 130 that is configured to receive and surround the first superconducting cable terminal 110. The surrounding part 130 is configured to cooperate with the first superconducting cable terminal 110. In the depicted example, the surrounding part 130 surrounds the first superconducting cable terminal 110, e.g., with an inner surface of the surrounding part 130 that engages an outer surface of the first superconducting cable terminal 110. The surrounding part 130 may be substantially tubular, in particular, with a circular cross-section. The surrounding part 130 may be concentric with the first superconducting cable terminal 110. The surrounding part 130 may comprise flanges 131 at its ends, however such flanges may be omitted, e.g., to aid tessellation.

The superconductor connector assembly 100 may further comprise a central part, such as a sleeve 140. The second superconducting terminal 120 may surround the sleeve 140, e.g., with an inner surface of the second superconducting cable terminal 120 that engages an outer surface of the sleeve 140. The second superconducting cable terminal 120 may be substantially tubular, in particular, with a circular cross-section. The second superconducting cable terminal 120 may be concentric with the sleeve 140. The sleeve 140 may define a passageway 142, which may receive a flow of coolant. In an alternative arrangement, the sleeve 140 may be replaced with a solid central part.

As best shown in FIG. 2b, the first and second openings 112, 122 overlap when the first and second superconducting cable terminals 110, 120 are assembled in the surrounding part 130. In particular, the first and second openings 112, 122 (and thus cables 102, 104) may overlap in a plane perpendicular to the longitudinal axis of the first and second openings. The first and second superconductor cables 102, 104 may extend through most (if not all) of the respective first and second openings 112, 122. The first and second superconductor cables 102, 104 may thus extend alongside one another for a significant portion of a length of the superconductor assembly 100. In this way, a good electrical connection can be provided between the first and second superconductor cables 102, 104 and their respective first and second superconducting terminals 110, 120 and the electrical resistance between the cables is minimised.

FIG. 2b shows the first and second superconductor cables 102,104 extending from opposite ends of the superconductor connector assembly 100, e.g., with the first superconductor cable 102 extending from a first end and the second superconductor cable 104 extending from a second end. The superconductor connector assembly 100 may thus be provided between the first and second superconductor cables 102, 104. However, it is also envisaged that the first and second superconductor cables 102, 104 may extend from the same end of the superconductor connector assembly 100.

The dimensions of the first and second superconducting cable terminals 110, 120 and the surrounding part 130 may permit assembly of the superconductor connector assembly 100, e.g., at a standard room temperature (approximately 298 K). However, the surrounding part 130 has a thermal expansion rate or coefficient that is different from a thermal expansion rate or coefficient of the first and second superconducting cable terminals 110, 120. The difference is such that the surrounding part 130 contracts more than the first and second superconducting cable terminals 110, 120 as the superconductor connector assembly 100 is cooled to an operating temperature (e.g., a cryogenic temperature of below approximately 100 K). As a result of the relative contraction rates, the first superconducting cable terminal 110 and the second superconducting cable terminal 120 are compressed together. This improves the performance of the electrical interface at the operating temperature of the superconductor connector assembly 100.

The central part or sleeve 140 may also have a different thermal expansion coefficient from that of the first and second superconducting cable terminals 110, 120. The central part or sleeve 140 may contract less than the second superconducting cable terminal 120 as the temperature reduces. For example, relative contraction as the temperature decreases may cause the second superconducting cable terminal 120 to be compressed against the sleeve 140. In this way, the first and second superconducting cable terminals 110, 120 may be compressed between the surrounding part 130 and sleeve 140.

The first and second superconducting cable terminals 110, 120 may be formed from copper, such as oxygen free high conductivity copper. The surrounding part 130 may be formed from aluminium. The sleeve 140 may be formed from steel, such as a stainless steel, Invar or any other material that contracts less than the first and/or second superconducting cable terminals 110, 120.

Although the first and second superconducting cable terminals 110, 120 may be made from the same material and may thus have the same thermal expansion properties, it is also envisaged that the first and second superconducting cable terminals 110, 120 may be formed from different materials and may have different thermal expansion properties. For example, the first superconducting cable terminal 110 may contract at a greater rate than the second superconducting cable terminal 120 as the temperature decreases. As such, cooling of the superconductor connector assembly 100 may cause compression between the first and second superconducting cable terminals 110, 120 due to their relative contraction rates.

The first and second openings 112, 122 may be the same size as or wider than the ends of the respective first and second superconductor cables 102, 104 (e.g. at both standard room temperature or at the operating temperature of the superconductor connector assembly 100). The first and second superconductor cables 102, 104 may be soldered into the first and second openings, e.g., with a solder 114, 124, such as an Indium based or eutectic solder. The solder 114, 124 may be soft (relative to the first and second superconducting terminals 110, 120) to minimise the compressive stress in the terminals 110, 120 being translated to the superconducting cables 102, 104. For example, the solder may (at the operating temperature of the superconductor connector assembly 100) have a Young's modulus or hardness value less than the material of the first and second superconducting cable terminals 110, 120. In particular, the solder may have a Young's modulus or hardness that is an order of magnitude less than the material of the first and second superconducting cable terminals 110, 120.

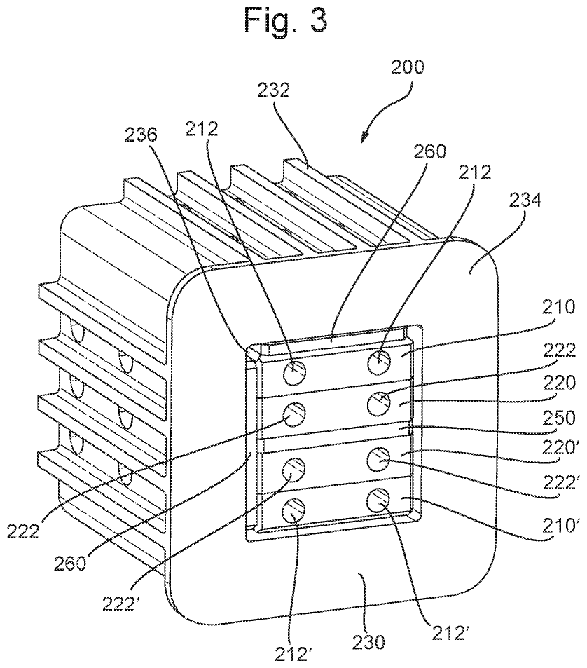

With reference to FIG. 3 another example of a superconductor connector assembly 200 is depicted. The superconductor connector assembly 200 differs from the superconductor connector assembly 100 in that the first superconducting cable terminal 210 and the second superconducting cable terminal 220 are provided alongside one another. In particular, neither of the first and second superconducting cable terminals 210, 220 surround the other of the first and second superconducting cable terminals. The surrounding part 230 surrounds both the first superconducting cable terminal 210 and the second superconducting cable terminal 220. Otherwise, features described in respect of the superconductor connector assembly 100 may also apply to the superconductor connector assembly 200. Furthermore, features described in respect of superconductor connector assembly 200 may also apply to the superconductor connector assembly 100.

The first and second superconducting cable terminals 210, 220 may have substantially the same cross-sectional shape (e.g., rectangular) and they may have substantially the same dimensions. The surrounding part 230 may define an opening that receives the first and second superconducting cable terminals 210, 220. The surrounding part opening may have a rectangular cross-section.

The superconductor connector assembly 200 may comprise a first pair of first and second superconducting cable terminals 210, 220 and a second pair of first and second superconducting cable terminals 210′, 220′. An electrical insulator 250 may be provided between the first pair of first and second superconducting cable terminals 210, 220 and the second pair of first and second superconducting cable terminals 210′, 220′. The insulator 250 may be formed from a stainless steel, such as an austenitic stainless steel, or any other insulating material. At cryogenic temperatures, stainless steel acts as an insulator. The superconductor connector assembly 200 may therefore connect more than one separate electrical connections.

Further pairs of first and second superconducting cable terminals may be provided, e.g., with insulators provided between neighbouring pairs. The first and second superconducting cable terminals may be arranged in rows within the surrounding part opening.

At least one further insulator 260 may be provided between an inner wall of the surrounding part 230 and the first and second superconducting cable terminals 210, 220. The further insulator 260 may be formed from a stainless steel, such as an austenitic stainless steel, or any other insulating material.

The first superconducting cable terminal 210 comprises at least one opening 212 for receiving a first superconductor cable (not shown in FIG. 2). The second superconducting cable terminal 220 comprises at least one opening 222 for receiving a second superconductor cable (not shown in FIG. 2). In the example shown, the first and second superconducting cable terminals 210, 220 each comprise two openings, although other numbers of openings are also contemplated. Each opening of a particular superconducting cable terminal may receive separate superconductor cables or ends/strands of a particular superconductor cable. As for the superconductor connector assembly 100, the first and/or second openings 212, 222 may be circular, e.g., to receive circular cable types (such as CORC™), or substantially square/rectangular to receive CICC (cable-in-conduit) or stacked tape type arrangements. The first and second openings 212, 222 may have different shapes, e.g., such that the superconductor connector assembly 200 provides an interface between different types of superconducting cables.

The same arrangement of openings may apply to the second pair of first and second superconducting cable terminals 210′, 220′ such that the first superconducting cable terminal 210′ comprises at least one opening 212′ and the second superconducting cable terminal 220′ comprises at least one opening 222′. The openings 212′, 222′ of the second pair of first and second superconducting cable terminals 210′, 220′ may receive different superconducting cables from the first pair of first and second superconducting cable terminals 210′, 220′.

The surrounding part 230 may comprise at least one rib 232. As shown, a plurality of ribs 232 may be provided. The ribs 232 may extend lengthways along an outer surface of the surrounding part 230, e.g., in the same direction as the openings 212, 222. Although not shown, ribs in other directions may be provided, e.g., extending around a perimeter of the surrounding part. The ribs 232 may increase the structural stiffness of the surrounding part 230. The ribs 232 may also increase a surface area of the surrounding part 230 and may increase heat transfer rates, e.g., from a cryogenic fluid. This may aid the cooling of the connector assembly 200 and the effective contraction of the surrounding part 230.

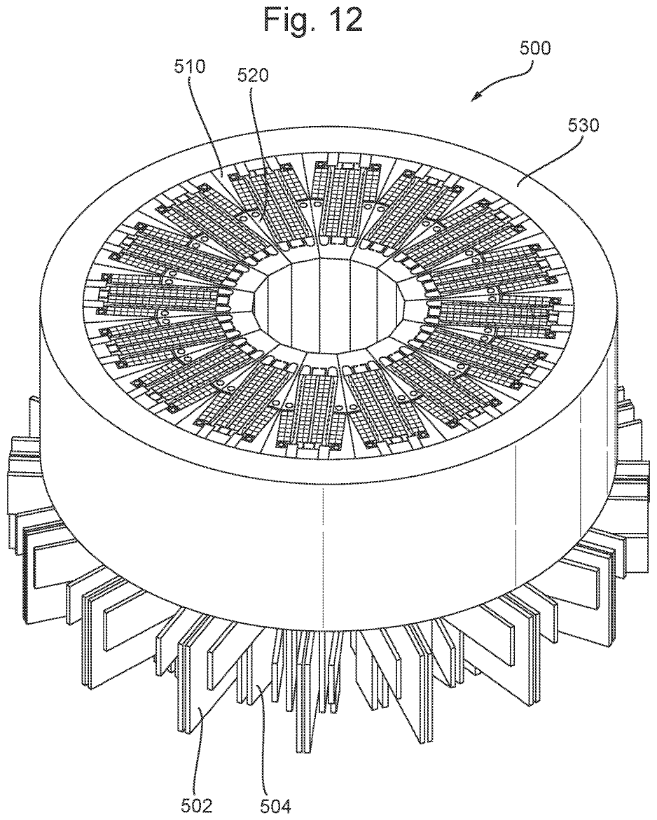

Furthermore, as will be described in more detail below with reference to FIG. 11, the ribs 232 may be positioned to engage with a recess or rib of a neighbouring superconductor connector assembly 200, so as to aid tessellation of neighbouring superconductor connector assemblies 200.

The surrounding part 230 may comprise a flange 234 around at least one end of the surrounding part 230. The ribs 232 may abut the flange 234. The flange 234 may improve structural rigidity of the 230.

The superconductor connector assembly 200 may comprise at least one coolant passageway configured to permit the flow of coolant through the superconductor connector assembly 200. The coolant may comprise a cryogenic fluid. For example, the first and/or second superconducting cable terminals 210, 220, 210′, 220′ may comprise additional openings or passageways 224, 224′ (shown in FIG. 11) to receive the flow of coolant. Such additional passageways 224, 224′ may extend through the length of the superconducting cable terminals.

Additionally or alternatively, at least one coolant passageway may be formed by a gap 236 between the surrounding part 230 and at least one of the first and second superconducting cable terminals 210, 220. Such gaps 236 may be formed between adjacent further insulators 260, e.g., at corners of the surrounding part 230 inner wall. The gaps 236 may help prevent the further insulators 260 from negatively affecting the compression imparted by the surrounding part 230, e.g., by ensuring that the further insulators 260 do not interfere with one another.

The superconductor connector assembly 200 otherwise functions in the same way as the superconductor connector assembly 100. In particular, the surrounding part 230 contracts more than the first and second superconducting cable terminals 210, 220, 210′, 220′ so that the first and second superconducting cable terminals are pressed together at the operating temperature of the superconductor connector assembly 200.

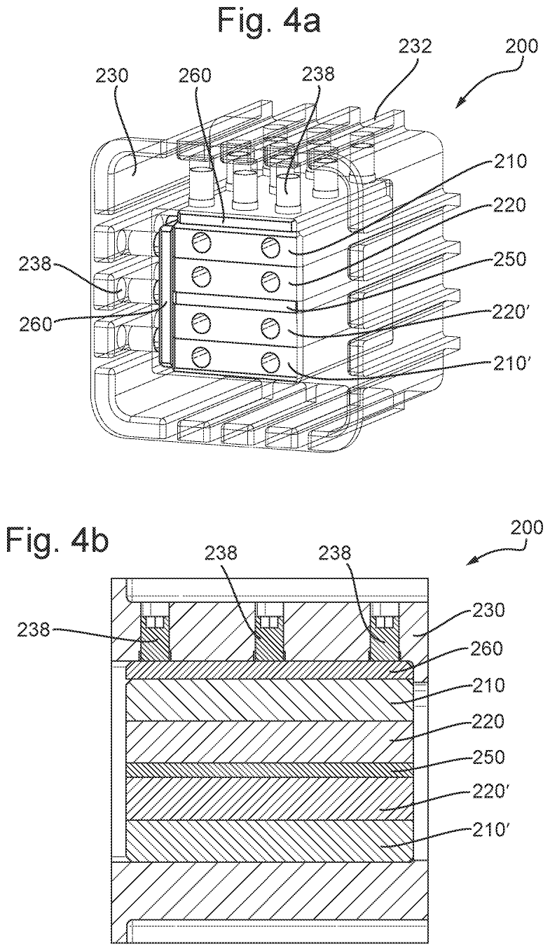

With reference to FIGS. 4 to 9, the superconductor connector assembly 200 may further comprise mechanical securing means configured to mechanically clamp the first and second superconducting cable terminals 210, 220 together. The mechanical securing means may be configured to provide a pre-stress that may compress the first and second superconducting cable terminals 210, 220 within the surrounding part 230, e.g. prior to the thermal contraction of the surrounding part. Such a pre-stress may assist the assembly of the superconductor connector assembly 200 and may help ensure that the first and second superconducting cable terminals 210, 220 do not fall out of the surrounding part 230 prior to thermal contraction. The mechanical securing means may also supplement the thermal stress caused by the contraction of the surrounding part 230. This may therefore increase the pressure acting on the first and second superconducting cable terminals 210, 220 and further improves the electrical connection performance therebetween.

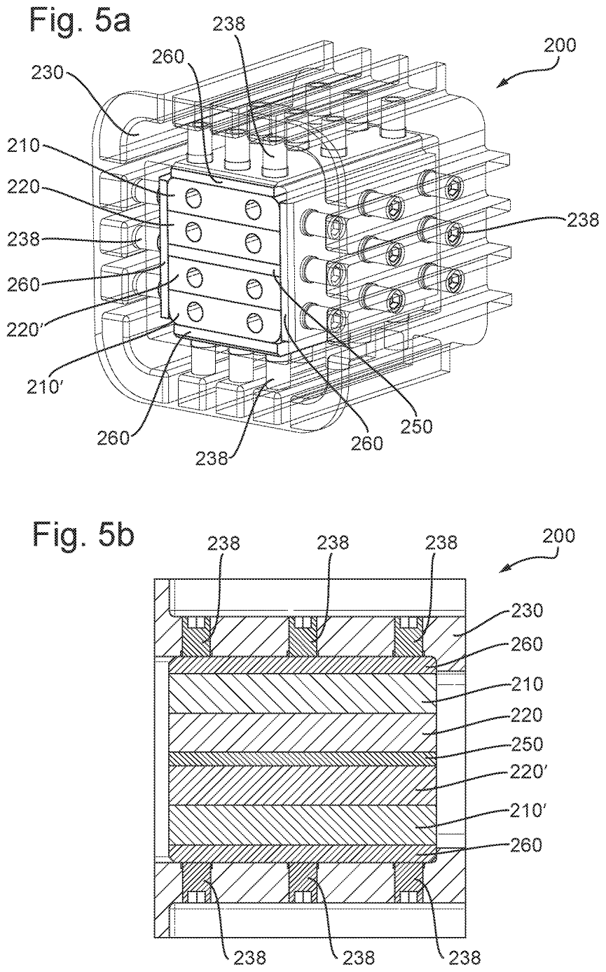

Referring to FIGS. 4 and 5, the mechanical securing means may comprise at least one bolt, stud or screw (not shown) that extends through at least one hole 238 in the surrounding part 230. As shown, there may be a plurality of holes 238 that may receive corresponding screws. The screws and holes 238 may extend through sidewalls of the surrounding part 230 in a lateral direction, e.g., substantially perpendicular to the longitudinal direction of the first and second openings. The holes 238 may be provided between ribs 232. The screws and holes 238 may be threaded such that the screws engage the thread in the hole and a pressure force at the end of the screw is transmitted to the surrounding part 230. The screws may act on the further insulator 260 which may in turn act on the first and/or second superconducting cable terminals 210, 220 and distribute the compressive force. Accordingly, the screws when tightened may compress the first and second superconducting cable terminals 210, 220 within the surrounding part 230.

FIG. 4 depicts an arrangement in which screws and holes 238 are provided on two (adjacent) sides of the surrounding part 230. FIG. 5 depicts an alternative arrangement in which the screws and holes 238 are provided on all sides of the surrounding part 230. However, the screws and holes may be provided on any number of sides or any other combination of sides (e.g., opposing sides).

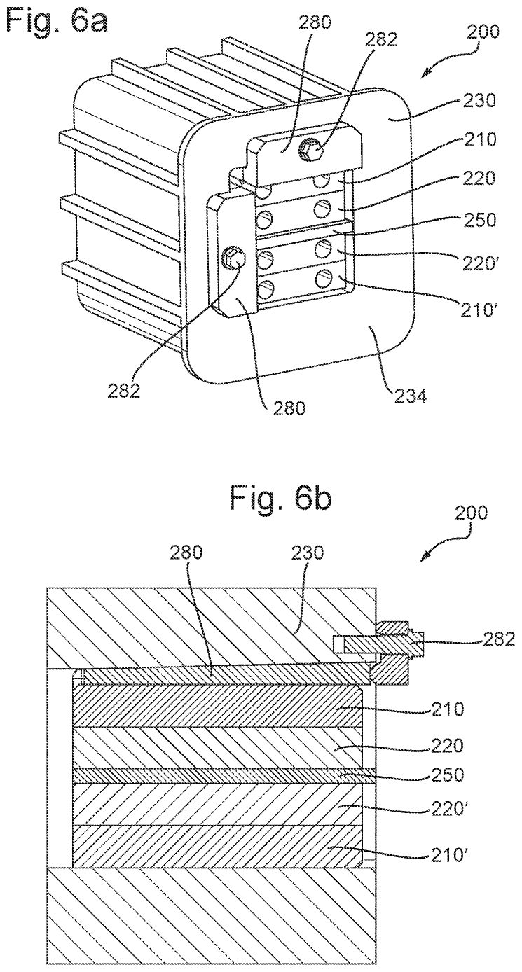

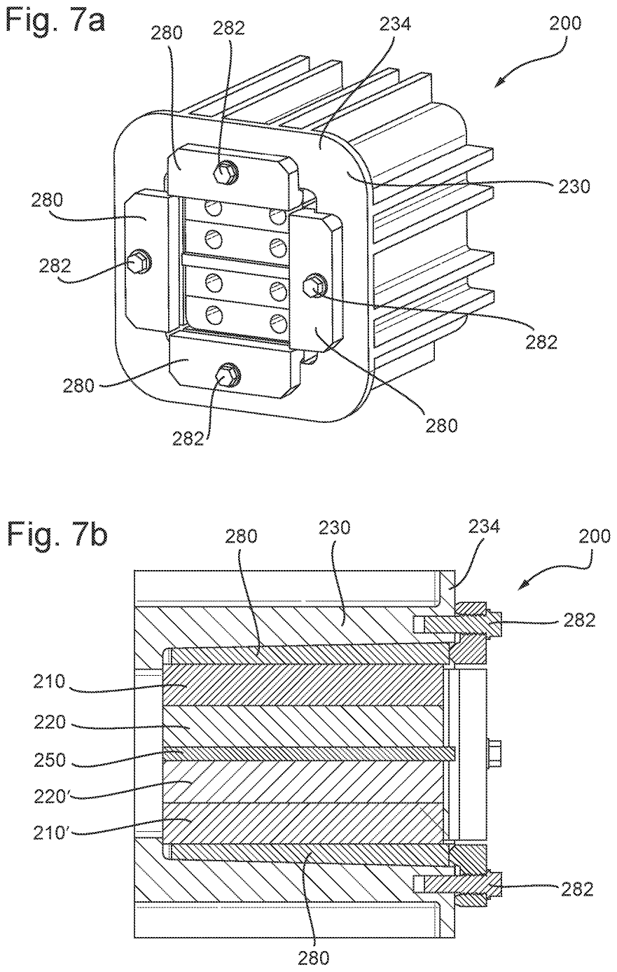

As shown in FIGS. 6 and 7, the mechanical securing means may comprise at least one wedge 280 for insertion between the surrounding part 230 and at least one of the first and second superconducting cable terminals 210, 220, 210′, 220′. The wedge 280 may replace (or be provided in addition to) one of the further insulators 260. The wedge 280 may be an insulator. The wedge 280 may be formed from a stainless steel such as an austenitic stainless steel, or any other insulating material. The wedge 280 may be inserted in a direction parallel to the longitudinal axis of the openings 212, 222. As best shown in FIGS. 6b and 7b, a taper angle of the wedge 280 may compress the first and second superconducting cable terminals 210, 220, 210′, 220′ within the surrounding part 230 when the wedge 280 is inserted.

FIG. 6 depicts an example with two wedges 280 that are arranged perpendicular to one another. In such an arrangement, the wedges 280 may compress the first and second superconducting cable terminals 210, 220, 210′, 220′ in perpendicular directions. FIG. 7 depicts another example with four wedges 280, e.g. with one wedge for each surface of the surrounding part inner wall. In the example of FIG. 7, a pair of wedges 280 may compress the first and second superconducting cable terminals 210, 220, 210′, 220′ in each direction. It will be appreciated that other number of wedges 280 may be used, for example, one, three or any other number.

Referring to FIGS. 6 to 9, the superconductor connector assembly 200 may further comprise at least one locking feature configured to lock or secure the mechanical securing means in place. For example, the locking feature may lock the wedges 280 into their inserted position. The locking feature may comprise a screw 282 that engages the surrounding part 230 to provide a reactive force that holds one of the wedges 280 in place. As shown in FIGS. 6 and 7, one screw 282 may be provided for each wedge 280. The screws 282 may extend through a tab at an end of each wedge 280 and into the flange 234 of the surrounding part 230. The screws 282 may extend in substantially the same direction as the first and second openings 212, 222 (and thus superconducting cables).

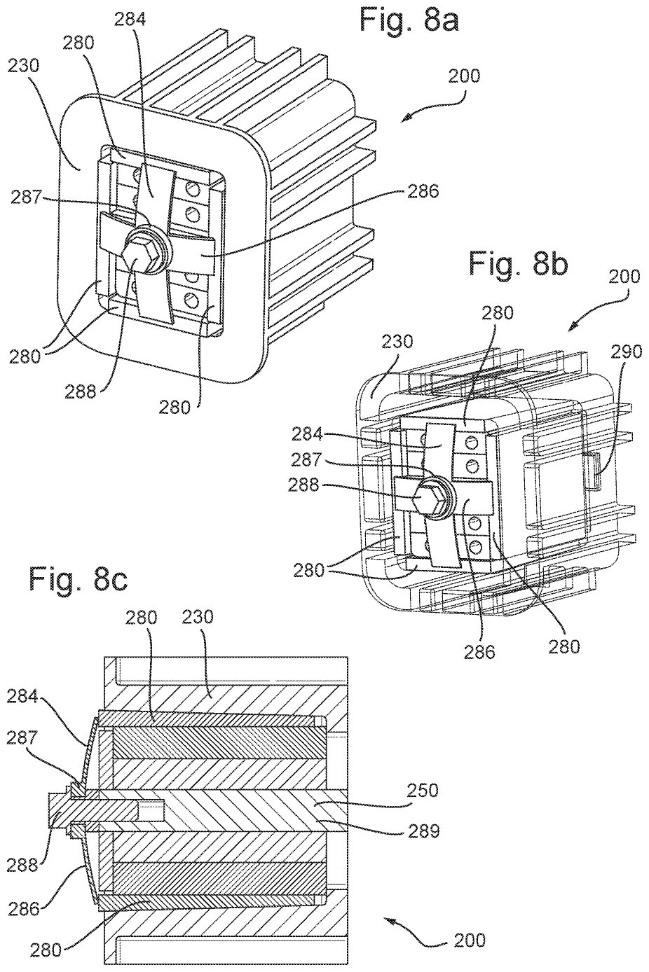

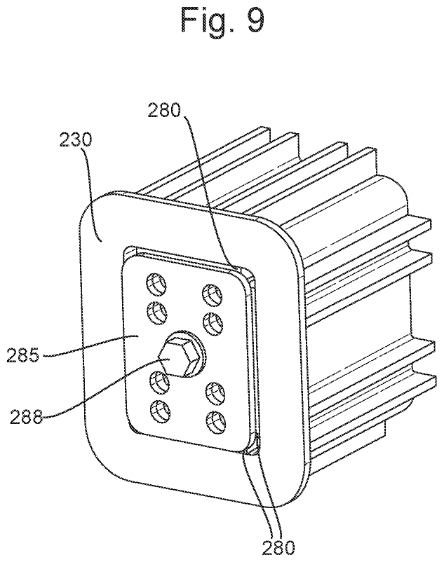

As mentioned above, one screw may be provided for each wedge 280. However, with reference to FIGS. 8 and 9, a single locking feature may be configured to lock or secure multiple wedges 280 into their inserted position. In the example shown in FIG. 8, the locking feature comprises a locking member 284, which comprises arms 286 radially extending from a hub 287. Each arm 286 may engage a respective wedge 280 at a distal end of the arm. In the depicted example with four wedges 280, the locking member 284 may have a cruciform shape. FIG. 9 shows an alternative arrangement in which the cruciform shaped locking member 284 is replaced with a locking member in the form of a plate 285. Edges of the plate 285 may engage the wedges 280 to hold the wedges in place. The plate 285 comprises a series of holes or slots aligning with the openings 212, 222 to permit passage of the superconducting cables. The shape of such holes or slots may correspond to the shape of the respective openings 212, 222.

In either of the examples shown in FIGS. 8 and 9, a screw 288 may engage the locking member 284. The screw 288 may in turn engage a reactive portion 289 that transmits a holding force to the surrounding part 230. Again, the screw 288 may extend in the same direction as the cable openings 212, 222. The reactive portion 289 may double up as the insulator 250 provided between the first pair of first and second superconducting cable terminals 210, 220 and the second pair of first and second superconducting cable terminals 210′, 220′. At one end the insulator 250 may comprise a threaded hole for receiving the screw 288. Another end of the insulator 250 may engage the surrounding part 230 to transmit a reactive force from the screw 288 to the surrounding part 230. For example, the insulator 250 may comprise a surface 290 that engages an edge of the surround part 230. The examples shown in FIGS. 8 and 9 advantageously reduces the number of screws that need to be tightened or loosened. This simplifies the assembly or disassembly process.

FIGS. 4 to 9 depict various possibilities for the mechanical securing means. However, it is also envisaged that the mechanical securing means may take a different form, such as an over-centre cam or any other type of mechanical means. The mechanical securing means may also apply to either of the superconductor connector assemblies 100, 200 described above. Regardless of what form the mechanical securing means takes, the mechanical securing means may be configured to be engaged or disengaged by remote tooling, e.g. remotely from the connector assembly 100, 200 and with the superconductor cables 102, 104 in situ. Likewise, the locking feature may be configured to be engaged or disengaged by remote tooling, e.g. remotely from the connector assembly 100, 200 and with the superconductor cables in situ.

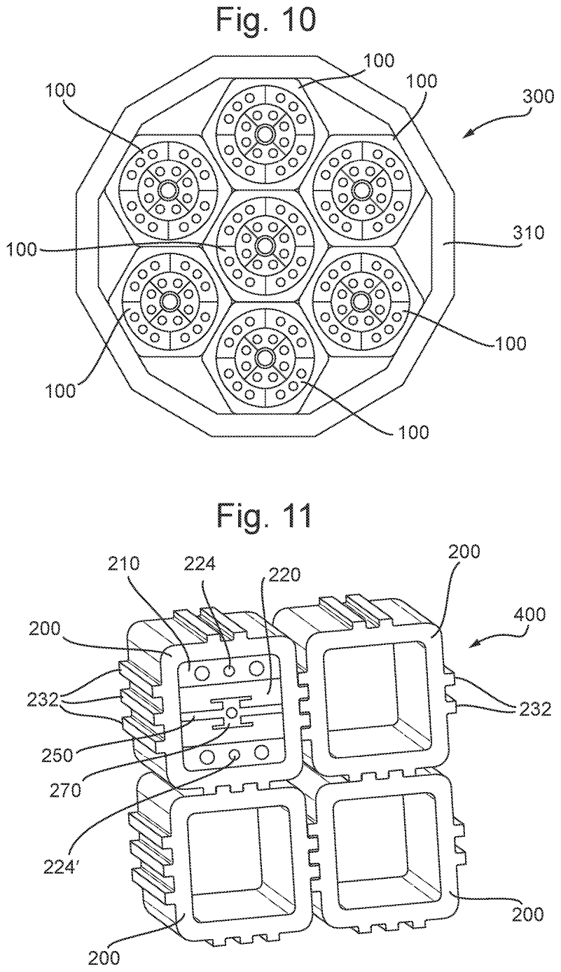

With reference to FIGS. 10 and 11 a plurality of the above-mentioned superconductor connector assemblies 100, 200 may be provided. The superconductor connector assemblies 100, 200 may connect, e.g. tesselate, with one another and may link together to form a wider assembly of connector assemblies 100, 200.

FIG. 10 depicts a first assembly 300 that comprises a plurality of superconductor connector assemblies, which correspond to the superconductor connector assembly 100 described above. However, to aid tessellation, the surrounding part 130 may be substantially hexagonal in shape. The first assembly 300 may comprise an outer sheath 310 that contains the plurality of superconductor connector assemblies 100.

FIG. 11 depicts a second assembly 400 that comprises a plurality of superconductor connector assemblies, which correspond to the superconductor connector assembly 200 described above. Although four superconductor connector assemblies 200 are depicted, it will be appreciated that more or fewer superconductor connector assemblies 200 may be provided. Also, the superconductor assemblies 200 may be arranged differently from that depicted in FIG. 11, e.g., in a line or any other shape/configuration. An outer sheath (not shown) may also be provided. Such an outer sheath may provide a layer of insulation. (FIG. 11 only shows one of the superconductor connector assemblies 200 with the first and second superconducting cable terminals 210, 220 inserted, however, it will be appreciated that the other superconductor connector assemblies 200 may comprise their respective first and second superconducting cable terminals 210, 220.)

As mentioned above, the surrounding part 230 may comprise one or more ribs 232. The ribs 232 may cooperate to connect the superconductor connector assemblies 200 together. For example, a rib 232 of one superconductor connector assembly 200 may cooperate with a rib or recess of a neighbouring superconductor connector assembly 200. The recess may be formed between two adjacent ribs 232. In this way, neighbouring connector assemblies 200 may interlock and a highly adaptable assembly may be provided.

FIG. 11 also depicts an optional locating feature 270 provided in the insulator 250 (which may be provided independently of the second assembly 400). The locating feature 270 may interlock with the adjacent first or second superconducting cable terminals 210, 220. The locating feature 270 may comprise an abutment shoulder that extends into a corresponding recess in the first or second superconducting cable terminals 210, 220. The locating feature 270 may assist in holding components together during assembly of the superconductor connector assembly 200.

With either of the arrangements depicted in FIGS. 10 and 11, gaps may be provided between neighbouring superconductor connector assemblies 100, 200 and/or the outer sheath 310. Such gaps may form passageways that may receive the flow of coolant, e.g., in a similar manner to the additional openings or passageways 224, 224′ shown in FIG. 11.

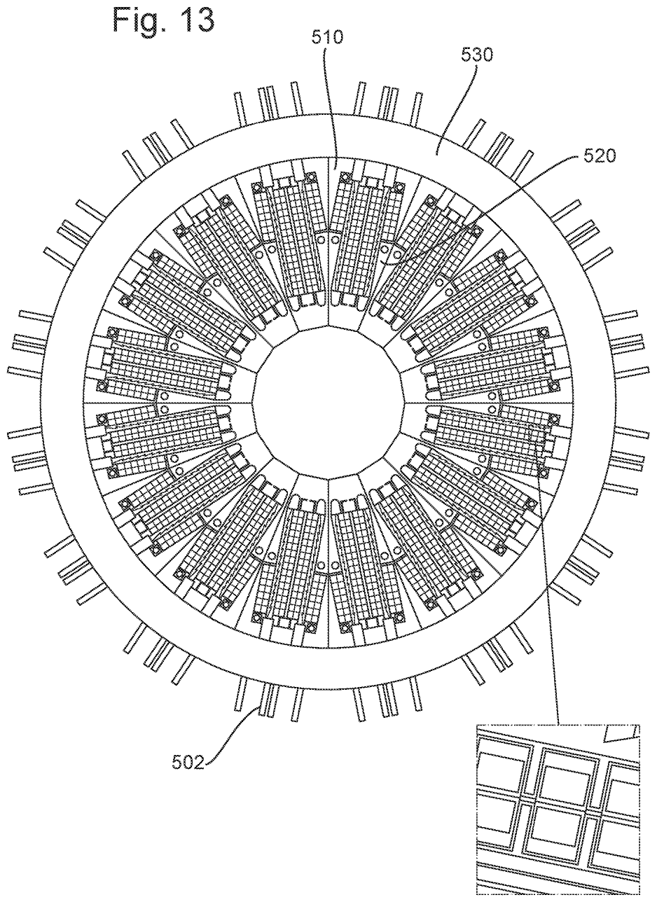

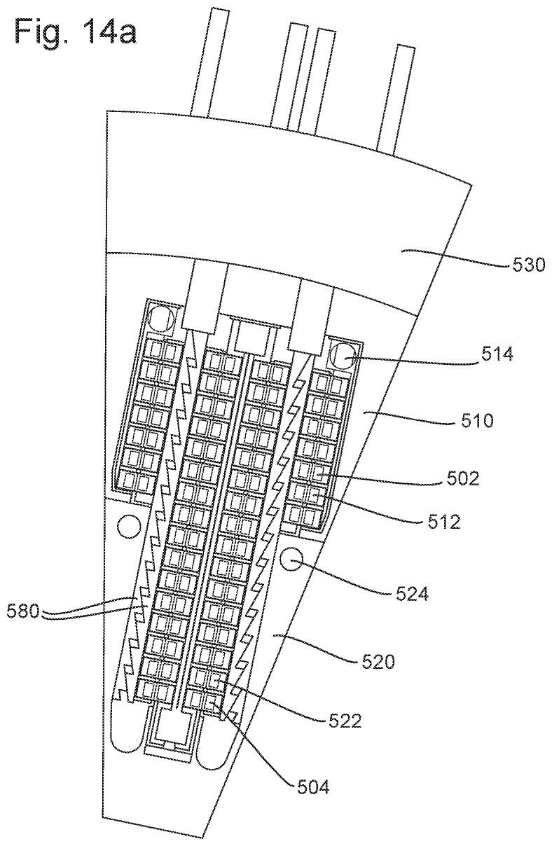

With reference to FIGS. 12 and 13, a further example of a superconductor connector assembly 500 is depicted. The superconductor connector assembly 500 differs from the superconductor connector assemblies 100, 200 in that the superconductor connector assembly 500 comprises a plurality of pairs of first and second superconducting cable terminals 510, 520. The surrounding part 530 collectively surrounds the pairs of first and second superconducting cable terminals 510, 520. Otherwise, features described in respect of the superconductor connector assemblies 100, 200 may also apply to the superconductor connector assembly 500. Furthermore, features described in respect of superconductor connector assembly 500 may also apply to the superconductor connector assemblies 100, 200.

Each pair of first and second superconducting cable terminals 510, 520 comprises first superconducting cable terminal 510 and second superconducting cable terminal 520 that are configured to be electrically coupled together to form an electrical connection. Each of the first and second superconducting cable terminals 510, 520 receives a corresponding superconducting cable 502, 504. Accordingly, each pair of the first and second superconducting cable terminals 510, 520 may electrically connect together the superconducting cables 502, 504 that are connected to that pair of first and second superconducting cable terminals 510, 520. However, as will be described in more detail below, neighbouring pairs of first and second superconducting cable terminals 510, 520 may be electrically isolated from one another.

As best shown in FIGS. 12 and 13, the pairs of the first and second superconducting cable terminals 510, 520 may be distributed in a circular arrangement, for example with each pair of the first and second superconducting cable terminals 510, 520 forming a truncated sector of the circular arrangement. (Each pair of the first and second superconducting cable terminals 510, 520 may be substantially trapezium shaped, e.g., with a curved surface that faces the surrounding part 530.) The pairs of the first and second superconducting cable terminals 510, 520 may be equiangularly distributed in the circular arrangement. The surrounding part 530 surrounds the pairs of the first and second superconducting cable terminals 510, 520. The surrounding part 530 may have a substantially annular cross-section. The pairs of the first and second superconducting cable terminals 510, 520 may also have a substantially annular cross-section.

The superconductor connector assembly 500 functions in substantially the same way as the superconductor connector assemblies 100, 200. In particular, the surrounding part 530 is configured to thermally contract more than the first and second superconducting cable terminals 510, 520, so that the first and second superconducting cable terminals are pressed together at the operating temperature of the superconductor connector assembly 500. As the surrounding part 530 contracts, the pairs of the first and second superconducting cable terminals 510, 520 are compressed together (e.g., in a circumferential direction) and the first and second superconducting cable terminals 510, 520 within each pair are also urged towards one another.

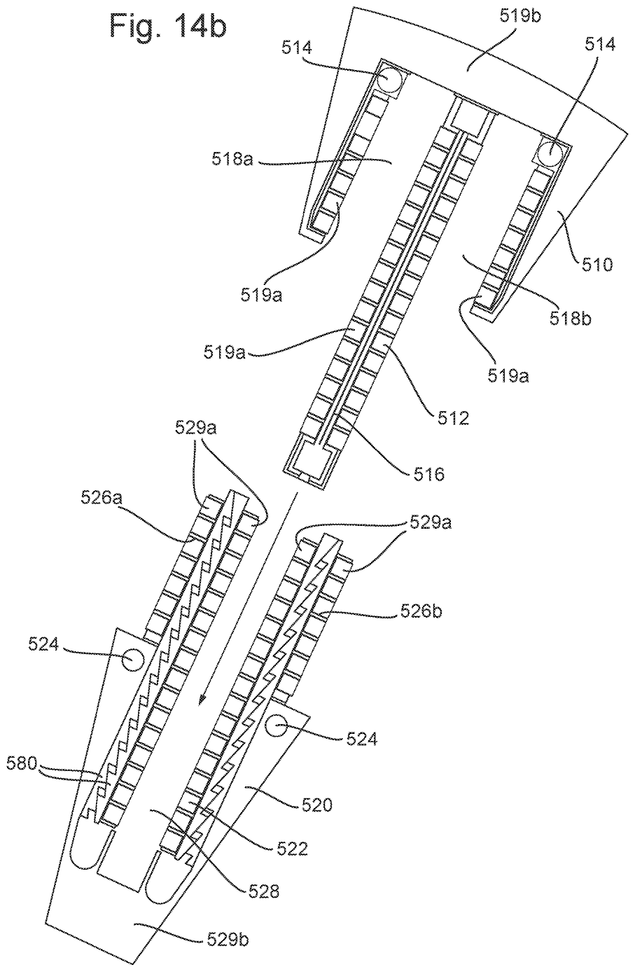

FIG. 14 shows a pair of the first and second superconducting cable terminals 510, 520. As depicted, the first and second superconducting cable terminals 510, 520 may interlock with respect to one another. For example, the first superconducting cable terminal 510 may comprise a protruding portion 516 and the second superconducting cable terminal 520 may comprise a receiving portion 528 configured to matingly receive the protruding portion 516. In addition, the second superconducting cable terminal 520 may comprise a pair of further protruding portions 526a, 526b and the first superconducting cable terminal 510 may comprise a pair of further receiving portion 518a, 518b configured to matingly receive the pair of further protruding portions 526a, 526b. The pair of further protruding portions 526a, 526b may be provided either side of (and may at least partially define) the receiving portion 528 of the second superconducting cable terminal 520. Likewise, the pair of further receiving portions 518a, 518b may be provided either side of the protruding portion 516 of the first superconducting cable terminal 510. As a result of this configuration, the first and second superconducting cable terminals 510, 520 may matingly interlock with respect to one another.

Opposing contact surfaces on the protruding portion 516 and the receiving portion 528 may form an electrical interface. Likewise, opposing contact surfaces on the pair of further protruding portions 526a, 526b and the pair of further receiving portion 518a, 518b may also form an electrical interface. In this way, a large contact area for the electrical interface may be provided. Electrical resistance at the interface may thus be reduced.

The protruding portion 516 and/or further protruding portions 526a, 526b may extend in a substantially radial direction of the superconductor connector assembly 500. Likewise, the opposing contact surfaces may also extend in a substantially radial direction of the superconductor connector assembly 500. As a result, the electrical interface may be perpendicular to the circumferential direction of the superconductor connector assembly 500. This orientation may maximise the contact pressure between the opposing electrical contact surfaces as the surrounding part 530 contracts. This again, may reduce the electrical resistance at the interface.

Referring still to FIG. 14, the first superconducting cable terminal 510 may comprise at least one conducting portion 519a and an insulating portion 519b. Likewise, the second superconducting cable terminal 520 may comprise at least one conducting portion 529a and an insulating portion 529b. The conducting portions 519a, 529a may provide at least part of the electrical interface. For example, side walls of the protruding portions 516, 526a, 526b and recesses 518a, 518b, 528 may comprise the conducting portions 519a, 529a. By contrast, the insulating portions 519b, 529b may be provided at least at an interface between neighbouring pairs of the first and second superconducting cable terminals 510, 520, e.g., such that neighbouring pairs may be insulated from one another. As best shown in FIG. 14b, the insulating portions 519b, 529b may form a carrier for the respective conducting portions 519a, 529a. The conducting portions 519a, 529a may be formed from an electrically conducting material, such as copper. The insulating portions 519b, 529b may be formed from an electrically insulating material, such as stainless steel.

The first superconducting cable terminal 510 may comprise first openings 512 for receiving the first superconductor cable 502 and the second superconducting cable terminal 520 may comprise second openings 522 for receiving the second superconductor cable 504. In particular, the conducting portion 519a of the first superconducting cable terminal 510 may comprise the first openings 512. Likewise, the conducting portion 529a of the second superconducting cable terminal 520 may comprise the second openings 522. The openings 512, 522 may be arranged in rows, e.g., with a row of openings 512, 522 for each of the opposing contact surfaces. FIG. 14a shows the first and second superconductor cables 502, 504 in place, whereas they have been omitted from FIG. 14b. In addition to the openings 512, 522, the first and second superconducting cable terminal 510, 520 may also comprise coolant passageways 514, 524.

Although separate first and second superconducting cable terminals 510, 520 have been described, it is also envisaged that the first and second superconducting cable terminals 510, 520 could be portions of a single piece item with said portions forming an electrical interface. It is also envisaged that the conducting portions 519a, 529a may be regarded as the first and second superconducting cable terminals 510, 520 respectively. In any event, contraction of the surrounding part 530 may force the electrical contact surfaces together to reduce electrical resistance.

Referring still to FIG. 14, the superconductor connector assembly 500 may further comprise a mechanical securing means in the form of opposing wedges 580. The wedges 580 may be provided between rows of conductor openings 522 in the second superconducting cable terminal 520. However, it is also envisaged that opposing wedges may additionally or alternatively be provided between rows of conductor openings 512 in the first superconducting cable terminal 510. One of the opposing wedges 580 may be linearly movable with respect to the other of the wedges 580 so that corresponding wedge surfaces slide with respect to one another and that a lateral dimension of the pair of opposing wedges is changed. In the particular example shown, moving one of the wedges 580 causes the lateral spacing (e.g., in the circumferential direction) between the rows of conductor openings 522 to increase. This in turn increases the contact pressure between the opposing electrical contact surfaces. The position of a wedge 580 may be adjusted mechanically, for example by virtue of a screw mechanism (not shown) extending through an opening in the surrounding part 530. As shown, there may be a plurality of opposing wedges 580 arranged in a saw tooth fashion. Such an arrangement provides an additional compression force on the electrical interface along the length of the electrical interface.

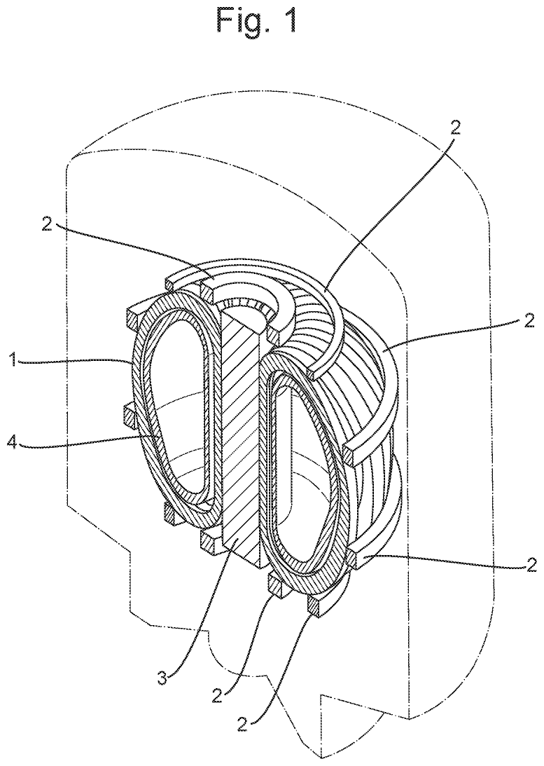

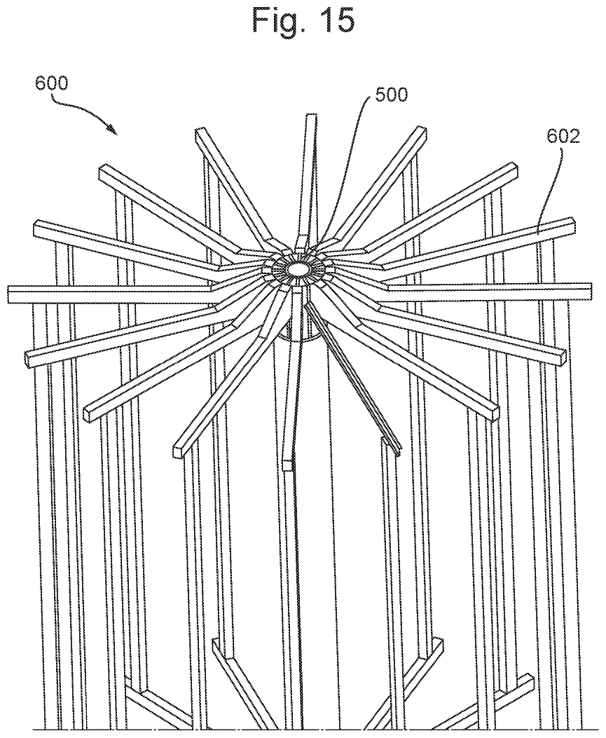

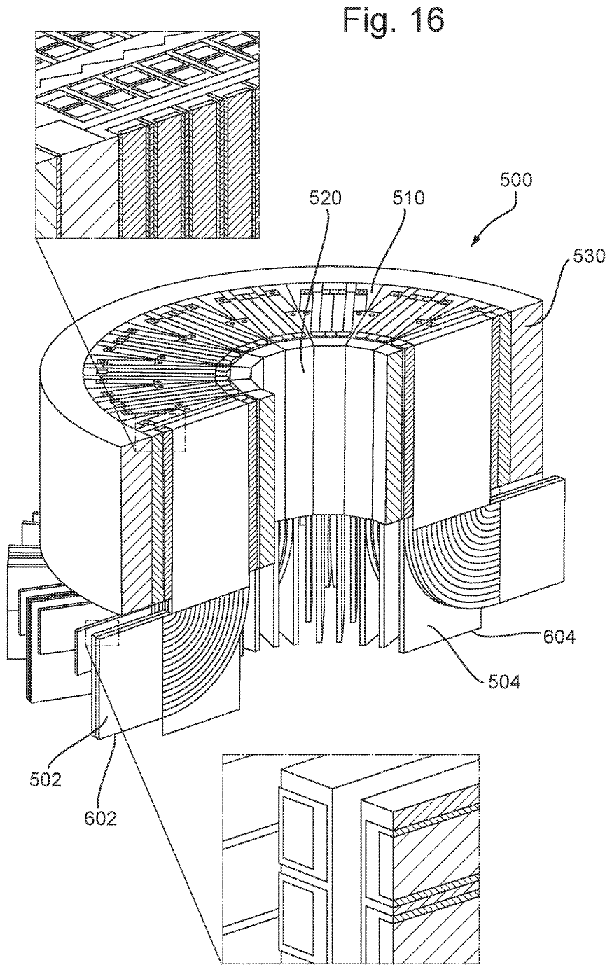

With reference to FIGS. 15 and 16, the superconductor connector assembly 500 may be provided in a superconducting toroidal field coil assembly 600. The superconducting toroidal field coil assembly 600 may correspond to the superconducting magnet assembly 1 depicted in FIG. 1. For example, each pair of the first and second superconducting cable terminals 510, 520 of the superconductor connector assembly 500 may be configured to connect ends of a particular superconducting toroidal field cable 602 together. In this way, the superconductor connector assembly 500 may connect all of the superconducting toroidal field cables 602 together with a single connector assembly. The superconductor connector assembly 500 may be provided centrally with respect to a toroidal vessel 4, e.g., for a nuclear fusion reactor. In particular, the superconductor connector assembly 500 may be provided at the top of the toroidal vessel 4.

FIG. 16 depicts the different paths of the first and second superconducting cables 502, 504 emanating from the superconductor connector assembly 500. The first and second superconducting cables 502, 504 correspond to first and second ends of a particular superconducting toroidal field cable 602, 604. First and second ends of the superconducting toroidal field cable 602, 604 may extend from the same side of the superconductor connector assembly 500. The first end of the superconducting toroidal field cable 602 (i.e., first superconducting cable 502) may initially extend vertically downwards, but may then rotate substantially 90 degrees and extend horizontally across the top of the toroidal vessel 4. The second end of the superconducting toroidal field cable 604 (i.e., second superconducting cable 504) may continue vertically downwards, e.g., through a centre of the toroidal vessel 4.

Although FIGS. 15 and 16 depict the superconductor connector assembly 500 provided at the top of the toroidal vessel 4, it is also envisaged that the superconductor connector assembly 500 may be additionally or alternatively provided at the bottom of the toroidal vessel 4.

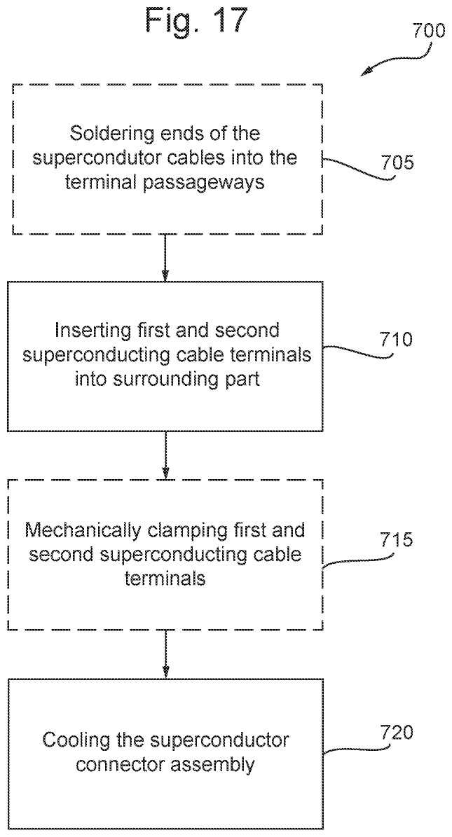

With reference to FIG. 17, the present disclosure relates to a method 700 of assembling a superconductor connector assembly 100, 200, 500 to electrically connect the first superconductor cable 102, 502 and the second superconductor cable 104, 504. The method 700 comprises inserting 710 the first superconducting cable terminal(s) 110, 210, 510 and the second superconducting cable terminal(s) 120, 220, 520 into the surrounding part 130, 230, 530 such that the first and second openings overlap. The method 700 further comprises cryogenically cooling 720 the superconductor connector assembly 100, 200, 500 such that the first superconducting cable terminal 110, 210, 510 and the second superconducting cable terminal 120, 220, 520 are compressed together and form an electrical interface at an operating temperature of the superconductor connector assembly.

The method 700 may further comprise, prior to cryogenically cooling 720 the superconductor connector assembly, mechanically clamping 715 the first and second superconducting cable terminals together to provide a pre-stress that compresses the first and second superconducting cable terminals within the surrounding part 130, 230, 530 (e.g., if a mechanical clamp is provided). The method 700 may further comprise locking the above-mentioned locking feature to lock or secure the at least one wedge into an inserted position.

The method 700 may further comprise, prior to inserting 710 the first superconducting cable terminal 110, 210, 510 and the second superconducting cable terminal 120, 220, 520 into the surrounding part 130, 230, 530, soldering 705 ends of the first and second superconductor cables 102, 502, 104, 504 into the respective first and second openings.

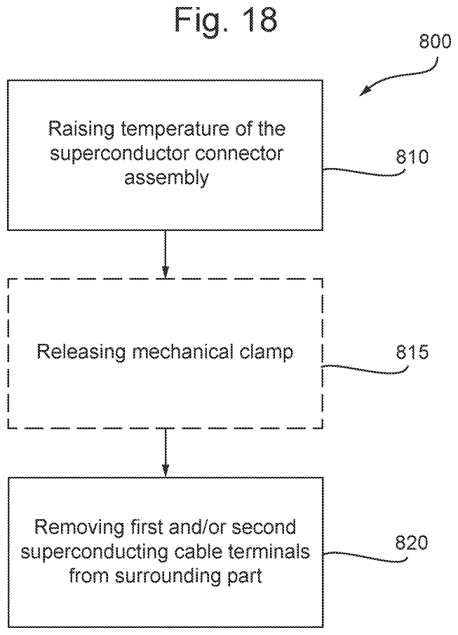

With reference to FIG. 18, the present disclosure relates to a method 800 of disassembling a superconductor connector assembly 100, 200, 500 to electrically disconnect the first superconductor cable 102, 502 and the second superconductor cable 104, 504. The method comprises raising 810 the temperature of the superconductor connector assembly 100, 200, 500 from the operating temperature such that the first superconducting cable terminal(s) 110, 210, 510 and the second superconducting cable terminal(s) 120, 220, 520 are decompressed (e.g., no longer under thermal compression). The method 800 further comprises loosening and removing 820 at least one of the first superconducting cable terminal(s) 110, 210, 510 and the second superconducting cable terminal(s) 120, 220, 520 from the surrounding part 130, 230, 530. The method 800 may further comprise, prior to removing 820 the first and/or second superconducting cable terminals, releasing 815 the mechanical clamp (e.g., if such a mechanical clamp is provided). Releasing 815 the mechanical clamp may comprise unlocking the above-mentioned locking feature.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-40. (canceled)

41. A superconductor connector assembly for electrically connecting a first superconductor cable and a second superconductor cable, the superconductor connector assembly comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that is configured to receive and surround the first superconducting cable terminal and the second superconducting cable terminal, wherein the first and second openings overlap when the first superconducting cable terminal and the second superconducting cable terminal are received in the surrounding part, and
wherein the surrounding part is made from a material that has a thermal expansion coefficient different from a thermal expansion coefficient of the first and second superconducting cable terminals such that the first superconducting cable terminal and the second superconducting cable terminal are compressed together and form an electrical interface at an operating temperature of the superconductor connector assembly.

42. The superconductor connector assembly of claim 41, wherein the first and second superconducting cable terminals are formed from oxygen free high conductivity copper.

43. The superconductor connector assembly of claim 41, wherein the first superconducting cable terminal and the second superconducting cable terminal are configured to be provided alongside one another.

44. The superconductor connector assembly of claim 41, wherein the superconductor connector assembly further comprises mechanical securing means configured to mechanically clamp the first and second superconducting cable terminals together.

45. The superconductor connector assembly of claim 44, wherein the mechanical securing means is configured to provide a pre-stress that compresses the first and second superconducting cable terminals within the surrounding part prior to the thermal contraction of the surrounding part.

46. The superconductor connector assembly of claim 44, wherein the mechanical securing means comprises at least one pair of opposing wedges, wherein one of the wedges is linearly movable with respect to the other of the wedges so that corresponding wedge surfaces slide with respect to one another and that a lateral dimension of the pair of opposing wedges is changed.

47. The superconductor connector assembly of claim 41, wherein the superconductor connector assembly comprises at least one coolant passageway configured to permit the flow of coolant through the superconductor connector assembly.

48. The superconductor connector assembly of claim 47, wherein at least one of the first and second superconducting cable terminals comprises the coolant passageway.

49. The superconductor connector assembly of claim 41, wherein the first and second superconducting cable terminals interlock with respect to one another.

50. The superconductor connector assembly of claim 49, wherein one of the first and second superconducting cable terminals comprises a protruding portion and the other of the first and second superconducting cable terminals comprises a receiving portion, the receiving portion being configured to receive the protruding portion.

51. The superconductor connector assembly of claim 50, wherein the electrical interface is provided by opposing surfaces on the protruding portion and the receiving portion.

52. The superconductor connector assembly of claim 41, wherein the superconductor connector assembly comprises a plurality of first superconducting cable terminals and a plurality of second superconducting cable terminals.

53. The superconductor connector assembly of claim 41, wherein the superconductor connector assembly comprises a plurality of pairs of first and second superconducting cable terminals, the pairs of the first and second superconducting cable terminals being distributed in a circular arrangement.

54. The superconductor connector assembly of claim 53, wherein each pair of the first and second superconducting cable terminals forms a truncated sector of the circular arrangement.

55. The superconductor connector assembly of claim 53, wherein the surrounding part surrounds the pairs of the first and second superconducting cable terminals distributed in the circular arrangement.

56. An assembly comprising the superconductor connector assembly of claim 41, the first superconductor cable, and the second superconductor cable.

57. The assembly of claim 56, wherein the assembly further comprises solder in the first and second openings, the solder connecting the first and second superconductor cables to the first and second superconducting cable terminals respectively, wherein the solder has a Young's modulus or hardness less than the material of the first and second superconducting cable terminals.

58. A superconducting toroidal field coil assembly comprising the superconductor connector assembly of claim 53, wherein each pair of the first and second superconducting cable terminals is configured to connect ends of a superconducting toroidal field cable together.

59. A method of assembling a superconductor connector assembly to electrically connect a first superconductor cable and a second superconductor cable, the superconductor connector comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that is configured to receive and surround the first superconducting cable terminal and the second superconducting cable terminal, wherein the surrounding part is made from a material that has a thermal expansion coefficient different from a thermal expansion coefficient of the first and second superconducting cable terminals,
wherein the method comprises the steps of:
inserting the first superconducting cable terminal and the second superconducting cable terminal into the surrounding part such that the first and second openings overlap; and
cryogenically cooling the superconductor connector assembly such that the first superconducting cable terminal and the second superconducting cable terminal are compressed together and form an electrical interface at an operating temperature of the superconductor connector assembly.

60. The method of claim 37 further comprising the step of, prior to cryogenically cooling the superconductor connector assembly, mechanically clamping the first and second superconducting cable terminals together to provide a pre-stress that compresses the first and second superconducting cable terminals within the surrounding part.

61. A method of disassembling a superconductor connector assembly to electrically disconnect a first superconductor cable and a second superconductor cable, the superconductor connector comprising:
at least one first superconducting cable terminal, the first superconducting cable terminal comprising at least one first opening for receiving an end of the first superconductor cable;
at least one second superconducting cable terminal, the second superconducting cable terminal comprising at least one second opening for receiving an end of the second superconductor cable; and
a surrounding part that receives and surrounds the first superconducting cable terminal and the second superconducting cable terminal such that the first and second openings overlap, wherein the surrounding part is made from a material that has a thermal expansion coefficient different from a thermal expansion coefficient of the first and second superconducting cable terminals such that the first superconducting cable terminal and the second superconducting cable terminal are compressed together and form an electrical interface at an operating temperature of the superconductor connector assembly,
wherein the method comprises the steps of:
raising the temperature of the superconductor connector assembly from the operating temperature such that the first superconducting cable terminal and the second superconducting cable terminal are decompressed; and
loosening at least one of the first superconducting cable terminal and the second superconducting cable terminal from the surrounding part.
